(19) United States
(12) Patent Application Publication
(10) Pub. No.: US 2011/0133110 A1
(43) Pub. Date: Jun. 9, 2011

(54) PROCESS FOR PRODUCING A POLYMER DISPERSION

(75) Inventors: Uwe Hartnagel, Lorsch (DE); Armin Alteheld, Bad Kreuznach (DE)

(73) Assignee: BASF SE, Ludwigshafen (DE)

(21) Appl. No.: 12/956,506

(22) Filed: Nov. 30, 2010

Related U.S. Application Data
(60) Provisional application No. 61/266,518, filed on Dec. 4, 2009.

(51) Int. Cl. C08K 5/3445; C08K 5/41; C08K 5/36; D06M 15/19; C14C 9/00

(52) U.S. Cl. 252/8.57; 524/106; 252/8.61

(57) ABSTRACT

Process for producing a dispersion of polymer particles in an ionic liquid.

### BRIEF SUMMARY OF THE INVENTION

The present invention relates to a process for producing a dispersion of polymer particles in an ionic liquid (ionic polymer dispersion), wherein an aqueous dispersion of polymer particles (aqueous polymer dispersion) is admixed with an ionic liquid and water is separated off from the mixture obtained.

The invention likewise relates to the use of this ionic polymer dispersion in various fields of application, in particular in the field of torque transmission and shock absorption.

### BACKGROUND OF THE INVENTION

The present invention proceeds from the following prior art.

WO 2004/78811 discloses the use of ionic liquids in the preparation of block or graft polymers by means of coupling reactions of the corresponding reactive components.

It was an object of the present invention to provide a process for producing novel polymer dispersions and also the novel polymer dispersions themselves.

The object was achieved by provision of the process defined at the outset.

### BRIEF DESCRIPTION OF THE DRAWINGS

FIG. 1 shows the shear stress versus the shear rate for Example 1 and the Comparative Example.

### DETAILED DESCRIPTION OF THE INVENTION

According to the invention, aqueous polymer dispersions are used. Aqueous polymer dispersions are generally known. They are fluid systems which comprise polymer balls, the polymer particles, comprising a plurality of intertwined polymer chains dispersed as disperse phase in an aqueous dispersion medium. The average diameter of the polymer particles is generally in the range from 10 to 1000 nm, often from 50 to 500 nm or from 80 to 300 nm. The polymer solids content of the aqueous polymer dispersions is generally from 10 to 70% by weight.

Aqueous polymer dispersions can be obtained, in particular, by free-radically initiated aqueous emulsion polymerization of ethylenically unsaturated monomers. This method has been described many times in the past and is therefore adequately known to those skilled in the art [cf., for example, Encyclopedia of Polymer Science and Engineering, vol. 8, pages 659 to 677, John Wiley & Sons, Inc., 1987; D. C. Blackley, Emulsion Polymerisation, pages 155 to 465, Applied Science Publishers, Ltd., Essex, 1975; D. C. Blackley, Polymer Latices, 2nd Edition, vol. 1, pages 33 to 415, Chapman & Hall, 1997; H. Warson, The Applications of Synthetic Resin Emulsions, pages 49 to 244, Ernest Benn, Ltd., London, 1972; J. Piirma, Emulsion Polymerisation, pages 1 to 287, Academic Press, 1982; F. Hölscher, Dispersionen synthetischer Hochpolymerer, pages 1 to 160, Springer-Verlag, Berlin, 1969 and the patent document DE-A 40 03 422]. The free-radically initiated aqueous emulsion polymerization is usually carried out by dispersing the ethylenically unsaturated monomers, generally with concomitant use of free-radical chain transfer agents and dispersants such as emulsifiers and/or protective colloids, in the aqueous medium and polymerizing them by means of at least one water-soluble free-radical polymerization initiator. The residual contents of unreacted ethylenically unsaturated monomers in the aqueous polymer dispersions obtained are frequently reduced by chemical and/or physical methods which are likewise known to those skilled in the art [see, for example, EP-A 771328, DE-A 19624299, DE-A 19621027, DE-A 19741184, DE-A 19741187, DE-A 19805122, DE-A 19828183, DE-A 19839199, DE-A 19840586 and 19847115], the polymer solids content is adjusted to a desired value by dilution or concentration or further customary additives such as bactericides, foam- or viscosity-modifying additives are added to the aqueous polymer dispersion.

Apart from these primary aqueous polymer dispersions, a person skilled in the art will also know of secondary aqueous polymer dispersions. These are aqueous polymer dispersions in whose production the polymer is produced outside the aqueous dispersion medium, for example in solution in a suitable nonaqueous solvent. This solution is subsequently transferred into the aqueous dispersion medium and, while dispersing, the solvent is removed, generally by distillation.

It is advantageous according to the invention to use, in particular, aqueous polymer dispersions whose polymer particles comprise
from 50 to 99.9% by weight of esters of acrylic and/or methacrylic acid with alkanols having from 1 to 12 carbon atoms and/or styrene or
from 50 to 99.9% by weight of styrene and/or butadiene, or
from 50 to 99.9% by weight of vinyl chloride and/or vinylidene chloride, or
from 40 to 99.9% by weight of vinyl acetate, vinyl propionate, vinyl esters of Versatic acid, vinyl esters of long-chain fatty acids and/or ethylene
in polymerized form.

It is particularly advantageous according to the invention to use aqueous polymer dispersions whose polymers comprise
from 0.1 to 5% by weight of at least one α,β-monoethylenically unsaturated monocarboxylic and/or dicarboxylic acid having from 3 to 6 carbon atoms and/or the amide thereof and
from 50 to 99.9% by weight of at least one ester of acrylic and/or methacrylic acid with alkanols having from 1 to 12 carbon atoms and/or styrene, or
from 0.1 to 5% by weight of at least one α,β-monoethylenically unsaturated monocarboxylic and/or dicarboxylic acid having from 3 to 6 carbon atoms and/or the amide thereof and
from 50 to 99.9% by weight of styrene and/or butadiene,
or
from 0.1 to 5% by weight of at least one α,β-monoethylenically unsaturated monocarboxylic and/or dicarboxylic acid having from 3 to 6 carbon atoms and/or the amide thereof and
from 50 to 99.9% by weight of vinyl chloride and/or vinylidene chloride,
or
from 0.1 to 5% by weight of at least one α,β-monoethylenically unsaturated monocarboxylic and/or dicarboxylic acid having from 3 to 6 carbon atoms and/or the amide thereof and
from 40 to 99.9% by weight of vinyl acetate, vinyl propionate, vinyl esters of Versatic acid, vinyl esters of long-chain fatty acids and/or ethylene
in polymerized form.

Apart from the abovementioned aqueous polymer dispersions, it is particularly advantageous, according to the invention, to use aqueous polymer dispersions which have dilatant properties. A person skilled in the art will know that having dilatant properties means that an aqueous polymer dispersion displays a significant viscosity increase under the action of shear forces, without this having a measurable time dependence. That is to say that dilatant dispersions display a steep increase in the shear stress at in the ideal case a constant shear rate, viz. the critical shear rate. This phenomenon known as shear thickening is reversible and isothermal.

Aqueous polymer dispersions having dilatant properties are disclosed, for example, in the documents EP-A 43464, in particular examples 1 to 3, EP-A 400416, in particular example 1 to 9, DE-A 3433085, in particular examples A to D and DE-A 19757669, in particular examples 1 to 30, which are expressly incorporated by reference into the present text.

According to the invention, preference is given to using aqueous polymer dispersions whose glass transition temperature is ≧−90 and ≦180° C., in particular ≧−70 and ≦120° C. and advantageously ≧−20 and ≦90° C. The glass transition temperature (Tg), is the limiting value of the glass transition temperature to which the glass transition temperature tends with increasing molecular weight, as described by G. Kanig (Kolloid-Zeitschrift & Zeitschrift far Polymere, vol. 190, page 1, equation 1). The glass transition temperature is determined by the DSC method (differential scanning calorimetry, 20 K/min, midpoint measurement, DIN 53 765).

According to Fox (T. G. Fox, Bull. Am. Phys. Soc. 1956 [Ser. II] 1, page 123, and Ullmann's Encyclopädie der technischen Chemie, vol. 19, page 18, 4th edition, Verlag Chemie, Weinheim, 1980), a good approximation to the glass transition temperature of at most weakly crosslinked copolymers is given by:

1/Tg=x1/Tg1+x2/Tg2+ . . . xn/Tgn,

where x1, x2, . . . xn are the mass fractions of the monomers 1, 2, . . . n and Tg1, Tg2, . . . Tgn are the glass transition temperatures of the polymers made up of only one of the monomers 1, 2, . . . n in degrees kelvin. The Tg values for the homopolymers of most monomers are known and reported, for example, in Ullmann's Encyclopedia of Industrial Chemistry, 5th edition, vol. A21, page 169, Verlag Chemie, Weinheim, 1992; further sources of glass transition temperatures of homopolymers are, for example, J. Brandrup, E. H. Immergut, Polymer Handbook, 1st Ed., J. Wiley, New York, 1966; 2nd Ed. J. Wiley, New York, 1975 and 3rd Ed. J. Wiley, New York, 1989.

The average diameter of the polymer particles comprised in the aqueous polymer dispersions which can be used according to the invention is generally in the range from 10 to 1000 nm, often from 50 to 500 nm or from 80 to 300 nm. Furthermore, the solids contents of the aqueous polymer dispersions which can be used according to the invention are generally ≧10 and ≦70% by weight, advantageously ≧30 and ≦70% by weight and particularly advantageously ≧40 and ≦60% by weight. Correspondingly, the aqueous polymer dispersions which can be used according to the invention comprise ≧30 and ≦90% by weight, advantageously ≧30 and ≦70% by weight and particularly advantageously ≧40 and ≦60% by weight, of water. Here, the solids contents and the water contents are determined by drying a defined amount (about 0.8 g) of the aqueous polymer dispersion to constant weight at 130° C. The solids content and the water content can be determined from the resulting weight loss.

It is essential to the process that the aqueous dispersion of polymer particles (aqueous polymer dispersion) be admixed with an ionic liquid and water be separated off from the mixture obtained.

For the purposes of the present text, ionic liquids are salts (compounds of cations and anions) which at atmospheric pressure (1 atm absolute) have a melting point of less than 200° C., preferably less than 150° C., particularly preferably less than 100° C. and very particularly preferably less than 80° C. According to the invention, the ionic liquids particularly advantageously have a melting point ≧−80 and ≦80° C. and very particularly advantageously ≧−45 and ≦60° C.

In a particularly preferred embodiment, the ionic liquids are liquid under normal conditions (1 atm absolute, 21° C.).

Preferred ionic liquids comprise an organic compound as cation (organic cation). Depending on the valence of the anion, the ionic liquid can comprise further cations, including metal cations, in addition to the organic cation.

The cations of particularly preferred ionic liquids are exclusively one organic cation or, in the case of polyvalent anions, a mixture of different organic cations.

Suitable organic cations are, in particular, organic compounds having heteroatoms such as nitrogen, sulfur, oxygen or phosphorus; in particular, the organic cations are compounds having an ammonium group (ammonium cations), an oxonium group (oxonium cations), a sulfonium group (sulfonium cations) or a phosphonium group (phosphonium cations).

In a particular embodiment, the organic cations of the ionic liquids are ammonium cations, i.e. nonaromatic compounds having a localized positive charge on the nitrogen atom, e.g. compounds having tetravalent nitrogen (quaternary ammonium compounds) or compounds having trivalent nitrogen, where one bond is a double bond, or aromatic compounds having a delocalized positive charge and at least one nitrogen atom, preferably one or two nitrogen atoms, in the aromatic ring system.

Preferred organic cations are quaternary ammonium cations which preferably have three or four aliphatic substituents, particularly preferably C₁-C₁₂-alkyl groups, which may be substituted by hydroxyl groups, on the nitrogen atom.

Particular preference is given to organic cations which comprise a heterocyclic ring system having one or two nitrogen atoms as constituents of the ring system. Possibilities are monocyclic, bicyclic, aromatic or nonaromatic ring systems. Mention may be made by way of example of bicyclic ring systems as are described in WO 2008/043837. The bicyclic systems of WO 2008/043837 are diazabicyclo derivatives, preferably made up of a 7-membered ring and a 6-membered ring, which comprise an amidinium group; mention may be made, in particular, of the 1,8-diazabicyclo[5.4.0]undec-7-enium cation.

Very particularly preferred organic cations comprise a five- or six-membered heterocyclic ring system having one or two nitrogen atoms as constituents of the ring system.

Possible organic cations of this type are, for example, pyridinium cations, pyridazinium cations, pyrimidinium cations, pyrazinium cations, imidazolium cations, pyrazolium cations, pyrazolinium cations, imidazolinium cations, thiazolium cations, triazolium cations, pyrrolidinium cations and imidazolidinium cations. These cations are described, for example, in WO 2005/113702. If necessary in order to achieve a positive charge on the nitrogen atom or in the aromatic ring system, the nitrogen atoms are each substituted by an organic group having generally not more than 20 carbon atoms, preferably a hydrocarbon group, in particular a C₁-C₁₆-alkyl group, in particular a C₁-C₁₀-alkyl group, particularly preferably a C₁-C₄-alkyl group.

The carbon atoms of the ring system can also be substituted by organic groups having generally not more than 20 carbon atoms, preferably a hydrocarbon group, in particular a C₁-C₁₆-alkyl group, in particular a C₁-C₁₀-alkyl group, particularly preferably a C₁-C₄-alkyl group.

Particularly preferred ammonium cations are quaternary ammonium cations, imidazolium cations, pyrimidinium cations and pyrazolium cations.

Very particular preference is given to imidazolium cations, in particular those having the formula I below.

The ionic liquids can comprise inorganic or organic anions.

Such anions are listed, for example, in the abovementioned WO 03/029329, WO 2007/076979, WO 2006/000197 and WO 2007/128268.

Possible anions are, in particular, those from
the group of halides and halogen-comprising compounds of the formulae:

F⁻,Cl⁻,Br⁻,I⁻,BF₄⁻,PF₆⁻,AlCl₄⁻,Al₂Cl₇⁻,Al₃Cl₁₀⁻,AlBr₄⁻,FeCl₄⁻,BCl₄⁻,SbF₆⁻,AsF₆⁻,ZnCl₃⁻,SnCl₃⁻,CuCl₂⁻,CF₃SO₃⁻,(CF₃SO₃)₂N⁻,CF₃CO₂⁻,CCl₃CO₂⁻,CN⁻,SCN⁻,OCN⁻,NO₂⁻,NO₃⁻,N(CN)⁻;
the groups of sulfates, sulfites and sulfonates of the general formulae:

SO₄²⁻,HSO₄⁻,SO₃²⁻,HSO₃⁻,R^{a}OSO₃⁻,R^{a}SO₃⁻;
the group of phosphates of the general formulae:

PO₄³⁻,HPO₄²⁻,H₂PO₄⁻,R^{a}PO₄²⁻,HR^{a}PO₄⁻,R^{a}R^{b}PO₄⁻;
the group of phosphonates and phosphinates of the general formulae:

R^{a}HPO₃⁻,R^{a}R^{b}PO₂⁻,R^{a}R^{b}PO₃⁻;
the group of phosphites of the general formulae:

PO₃³⁻,HPO₃²⁻,H₂PO³⁻,R^{a}PO₃²⁻,R^{a}HPO³⁻,R^{a}R^{b}PO³⁻;
the group of phosphonites and phosphinites of the general formulae:

R^{a}R^{b}PO₂⁻,R^{a}HPO₂⁻,R^{a}R^{b}PO⁻,R^{a}HPO⁻;
the group of carboxylates of the general formula:

R^{a}COO⁻;
the group of borates of the general formulae:

BO₃³⁻,HBO₃²⁻,H₂BO₃⁻,R^{a}R^{b}BO₃⁻,R^{a}HBO₃⁻,R^{a}BO₃²⁻,B(OR^{a})(OR^{b})(OR^{c})(OR^{d})⁻,B(HSO₄)⁻,B(R^{a}SO₄)⁻;
the group of boronates of the general formulae:

R^{a}BO₂²⁻,R^{a}R^{b}BO⁻;
the group of carbonates and carbonic esters of the general formulae:

HCO₃⁻,CO₃²⁻,R^{a}CO₃⁻;
the group of silicates and silicic esters of the general formulae:

SiO₄⁴⁻,HSiO₄³⁻,H₂SiO₄²⁻,H₃SiO₄⁻,R^{a}SiO₄³⁻,R^{a}R^{b}SiO₄²⁻,R^{a}R^{b}R^{c}SiO₄²⁻,HR^{a}SiO₄²⁻,H₂R^{a}SiO₄⁻,HR^{a}R^{b}SiO₄⁻;
the group of alkylsilane and arylsilane salts of the general formulae:

R^{a}SiO₃³⁻,R^{a}R^{b}SiO₂²⁻,R^{a}R^{b}R^{c}SiO⁻,R^{a}R^{b}SiO₃²⁻;
the group of carboximides, bis(sulfonyl)imides and sulfonylimides of the general formulae:

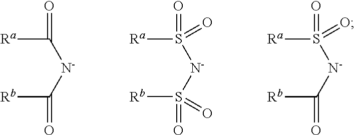

the group of methides of the general formula:

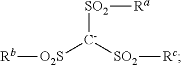

the group of alkoxides and aryloxides of the general formula:

RₐO⁻;
the group of halometalates of the general formula

[MᵣHalₜ]^{s-};
where M is a metal and Hal is fluorine, chlorine, bromine or iodine, r and t are positive integers and indicate the stoichiometry of the complex and s is a positive integer and indicates the charge on the complex;
the group of sulfides, hydrogensulfides, polysulfides, hydrogenpolysulfides and thiolates of the general formulae:

S²⁻,HS⁻,[Sᵥ]²⁻,[HSᵥ]⁻,[R^{a}S]⁻,
where v is a positive integer from 2 to 10; and
the group of complex metal ions such as Fe(CN)₆³⁻, Fe(CN)₆⁴⁻, MnO₄⁻, Fe(CO)₄⁻.

In the above anions, R^{a}, R^{b}, R^{c} and R^{d} are each, independently of one another,
hydrogen, C₁-C₃₀-alkyl or aryl-, heteroaryl-, cycloalkyl-, halogen-, hydroxy-, amino-, carboxy-, formyl-, —O—, —CO—, —CO—O— or —CO—N<substituted derivatives thereof, for example methyl, ethyl, 1-propyl, 2-propyl, 1-butyl, 2-butyl, 2-methyl-1-propyl(isobutyl), 2-methyl-2-propyl(tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, triacontyl, phenylmethyl(benzyl), diphenylmethyl, triphenylmethyl, 2-phenylethyl, 3-phenylpropyl, cyclopentylmethyl, 2-cyclopentylethyl, 3-cyclopentylpropyl, cyclohexylmethyl, 2-cyclohexylethyl, 3-cyclohexylpropyl, methoxy, ethoxy, formyl, acetyl or C_{q}F_{2(q-a)}(1−b)H_{2a+b} where q≦30, 0≦a≦q and b=0 or 1 (for example CF₃, C₂F₅, CH₂CH₂—C_{(q-2})F_{2(q-2)+1}, C₆F₁₃, C₈F₁₇, C₁₀F₂₁, C₁₂F₂₅);
C₃-C₁₂-Cycloalkyl and aryl-, heteroaryl-, cycloalkyl-, halogen-, hydroxy-, amino-, carboxy-, formyl-, —O—, —CO— or —CO—O-substituted derivatives thereof, for example cyclopentyl, 2-methyl-1-cyclopentyl, 3-methyl-1-cyclopentyl, cyclohexyl, 2-methyl-1-cyclohexyl, 3-methyl-1-cyclohexyl, 4-methyl-1-cyclohexyl or C_{q}F_{2(q-a)}−(1−b)H_{2a-b}, where q≦30, 0≦a≦q and b=0 or 1;
C₂-C₃₀-Alkenyl and aryl-, heteroaryl-, cycloalkyl-, halogen-, hydroxy-, amino-, carboxy-, formyl-, —O—, —CO— or —CO—O-substituted derivatives thereof, for example 2-propenyl, 3-butenyl, cis-2-butenyl, trans-2-butenyl or C_{q}F_{2(q-a)}−(1−b)H_{2a-b} where q≦30, 0≦a≦q and b=0 or 1;
C₃-C₁₂-Cycloalkenyl and aryl-, heteroaryl-, cycloalkyl-, halogen-, hydroxy-, amino-, carboxy-, formyl-, —O—, —CO— or —CO—O-substituted derivatives thereof, for example 3-cyclopentenyl, 2-cyclohexenyl, 3-cyclohexenyl, 2,5-cyclohexadienyl or
C_{q}F_{2(q-a)}−3(1−b)H_{2a-3b} where q≦30, 0≦a≦q and b=0 or 1;
Aryl or heteroaryl having from 2 to 30 carbon atoms and alkyl-, aryl-, heteroaryl-, cycloalkyl-, halogen-, hydroxy-, amino-, carboxy-, formyl-, —O—, —CO— or —CO—O-substituted derivatives thereof, for example phenyl, 2-methyl-phenyl (2-tolyl), 3-methyl-phenyl (3-tolyl), 4-methylphenyl, 2-ethylphenyl, 3-ethylphenyl, 4-ethylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 4-phenylphenyl, 1-naphthyl, 2-naphthyl, 1-pyrrolyl, 2-pyrrolyl, 3-pyrrolyl, 2-pyridinyl, 3-pyridinyl, 4-pyridinyl or C₆F₍₅₋ₐ)Hₐ where 0≦a≦5; or
two radicals form an unsaturated, saturated or aromatic ring which may be substituted by functional groups, aryl, alkyl, aryloxy, alkyloxy, halogen, heteroatoms and/or heterocycles and may be interrupted by one or more oxygen and/or sulfur atoms and/or one or more substituted or unsubstituted imino groups.

In the above anions, preference is given to R^{a}, R^{b}, R^{c} and R^{d} each being, independently of one another, a hydrogen atom or a C₁-C₁₂-alkyl group.

Anions which may be mentioned are, for example, chloride; bromide; iodide; thiocyanate; hexafluorophosphate; trifluoromethanesulfonate; methanesulfonate; the carboxylates, in particular formate; acetate; mandelate; nitrate; nitrite; trifluoroacetate; sulfate; hydrogensulfate; methylsulfate; ethylsulfate; 1-propylsulfate; 1-butylsulfate; 1-hexylsulfate; 1-octylsulfate; phosphate; dihydrogenphosphate; hydrogenphosphate; dialkylphosphates; propionate; tetrachloroaluminate Al₂Cl₇⁻; chlorozincate; chloroferrate; bis(trifluoromethylsulfonyl)imide; bis(pentafluoroethylsulfonyl)imide;
bis(methylsulfonyl)imide; bis(p-toluenesulfonyl)imide; tris(trifluoromethylsulfonyl)methide; bis(pentafluoroethylsulfonyl)methide; p-toluenesulfonate; tetracarbonylcobaltate; dimethylene glycol monomethyl ether sulfate; oleate; stearate; acrylate; methacrylate; maleate; hydrogencitrate; vinylphosphonate; bis(pentafluoroethyl)phosphinate; borates such as bis[salicylato(2-)]borate, bis[oxalato(2-)]borate, bis[1,2-benzenediolato(2-)-O,O′]borate, tetracyanoborate, tetrafluoroborate; dicyanamide; tris(pentafluoroethyl)trifluorophosphate; tris(heptafluoropropyl)trifluorophosphate, cyclic arylphosphates such as catecholphosphate (C₆H₄O₂)P(O)O⁻ and chlorocobaltate.

Particularly preferred anions are those from the group of
alkylsulfates R^{a}OSO₃⁻,
where R^{a} is a C₁-C₁₂-alkyl group, preferably a C₁-C₆-alkyl group,
alkylsulfonates R^{a}SO₃⁻,
where R^{a} is a C₁-C₁₂-alkyl group, preferably a C₁-C₆-alkyl group,
halides, in particular chloride and bromide and
pseudohalides such as thiocyanate, dicyanamide,
carboxylates R^{a}COO⁻,
where R^{a} is a C₁-C₂₀-alkyl group, preferably a C₁-C₈-alkyl group, in particular acetate,
phosphates,
in particular the dialkylphosphates of the formula R^{a}R^{b}PO₄⁻, where R^{a} and R^{b} are each, independently of one another, a C₁-C₆-alkyl group; in particular, R^{a} and R^{b} are the same alkyl group, with mention being made of dimethylphosphate and diethylphosphate,
and phosphonates, in particular the monoalkylphosphonic esters of the formula R^{a}R^{b}PO₃⁻, where R^{a} and R^{b} are each, independently of one another, a C₁-C₆-alkyl group.

Very particularly preferred anions are chloride, bromide, hydrogensulfate, tetrachloroaluminate, thiocyanate, dicyanamide, methylsulfate, ethylsulfate, methanesulfonate, formate, acetate, dimethylphosphate, diethylphosphate, p-toluenesulfonate, tetrafluoroborate and hexafluorophosphate, methylmethylphosphonate and methylphosphonate.

Particularly preferred ionic liquids are imidazolium salts of the formula I:

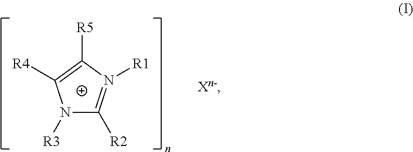

where
R¹ and R³ are each an organic radical having from 1 to 20 carbon atoms,
R², R⁴ and R⁵ are each an H atom or an organic radical having from 1 to 20 carbon atoms,
X is an anion and
n is 1, 2 or 3.

In formula I, preference is given to R¹ and R³ each being, independently of one another, an organic radical having from 1 to 10 carbon atoms. In particular, R¹ and R³ are each an aliphatic radical, in particular an aliphatic radical without further heteroatoms, e.g. an alkyl group. Particular preference is given to R¹ and R³ each being, independently of one another, a C₁-C₁₀-alkyl group or a C₁-C₄-alkyl group.

In formula I, preference is given to R², R⁴ and R⁵ each being, independently of one another, an H atom or an organic radical having from 1 to 10 carbon atoms. Particular preference is given to R², R⁴ and R⁵ each being, independently of one another, an H atom or a alkyl group; in particular, R², R⁴ and R⁵ are each, independently of one another, an H atom or a C₁-C₄-alkyl group. Very particular preference is given to R², R⁴ and R⁵ each being an H atom.

X is an anion, preferably one of the abovementioned anions, particularly preferably chloride, methanesulfonate, thiocyanate, methylsulfate, ethylsulfate and/or acetate.

n is preferably 1.

Particularly preferred ionic liquids consist exclusively of an organic cation with of the above anions.

The molecular weight of the ionic liquid is preferably less than 2000 g/mol, particularly preferably less than 1500 g/mol, particularly preferably less than 1000 g/mol and very particularly preferably less than 750 g/mol. In a particular embodiment, the molecular weight is in the range from 100 to 750 g/mol or in the range from 100 to 500 g/mol.

According to the invention, it is particularly advantageous to use 1-ethyl-3-methylimidazolium chloride, 1-ethyl-3-methylimidazolium methanesulfonate, 1-ethyl-3-methylimidazolium thiocyanate, 1-ethyl-3-methylimidazolium ethylsulfate, 1-butyl-3-methylimidazolium methanesulfonate, 1-butyl-3-methylimidazolium chloride and/or 1-ethyl-3-methylimidazolium acetate as ionic liquid.

According to the invention, ≧40 and ≦9900 parts by weight, advantageously ≧45 and ≦3000 parts by weight and particularly advantageously ≧50 and ≦300 parts by weight, of ionic liquid are added to the aqueous polymer dispersion per 100 parts by weight of polymer particles.

The way in which the ionic liquid is added to the aqueous polymer dispersion is generally not critical and the addition can be carried out discontinuously in one or more portions or continuously using constant or changing flow rates. It is advantageous for the ionic liquid to be added to the aqueous polymer dispersion with homogeneous mixing, for example by means of conventional stirrers, static and/or dynamic mixing devices. It is important that the ionic liquid is selected so that the ionic liquid and the aqueous polymer dispersion do not adversely affect one another, for example by coagulum formation or precipitation of the polymer, which in the case of doubt can be tested by a person skilled in the art with the aid of a few routine experiments.

Water is separated off from the resulting mixture comprising the ionic liquid and the aqueous polymer dispersion in a manner known to those skilled in the art, for example with continual mixing, by means of a rotary evaporator, falling film evaporator, a freeze drying apparatus and/or a simple distillation attachment, advantageously at a temperature of the mixture in the range from ≧−20 to ≦100° C. and in particular in the range from ≧30 to ≦90° C. The removal of water is particularly advantageously carried out a pressure of <1 atm (absolute), with pressures in the range from ≧0.1 to ≦700 mbar (absolute) or from ≧10 to ≦500 mbar (absolute) being particularly preferred.

According to the invention, at least ≧50% by weight, advantageously ≧70% by weight and particularly advantageously ≧90% by weight, of the total amount of water comprised in the mixture is separated off from the resulting mixture comprising the ionic liquid and the aqueous polymer dispersion. The total amount of water is frequently separated off. However, in embodiments of the invention it can be advantageous for not the total amount of water but only ≧93 and ≦99% by weight of the total amount of water to be separated off. This can be the case, for example, when the pure ionic liquid is not liquid at room temperature. It is important that small amounts of water greatly reduce the melting point of the ionic liquid, so that the latter is liquid in the desired temperature range. It can also be possible for residual amounts of water to be able to be removed from the resulting dispersion only with difficulty or only with a large outlay in terms of time and energy, so that it can be more economical to leave these residual amounts of water in the dispersion obtained.

Apart from the aqueous and nonaqueous components of the aqueous polymer dispersions and the ionic liquids, the ionic polymer dispersions of the invention can additionally comprise further customary additives, for example fillers such as calcium carbonate, talc, dolomite and precipitated silica, pigments such as titanium dioxide, pigment dispersants, rheological additives, preservatives, antifoams and/or biocides.

The ionic polymer dispersions which can be obtained according to the invention are mechanically stable and can therefore be stored for many months. They can be used, for example, for producing adhesives, sealants, polymer renders, paper coatings, fiber nonwovens, coating compositions and impact modifiers and also for consolidating sand, textile finishing, leather finishing or for modifying mineral binders and plastics.

In addition, it is of importance that, when an aqueous polymer dispersion having dilatant properties is used, the ionic polymer dispersion which can be obtained therefrom according to the invention generally also has dilatant properties. These ionic polymer dispersions having dilatant properties can advantageously be used as medium for transmitting torque, for example in vibration dampers, revolution limiters or hydraulic clutches, and also for shock absorption, for example as filling in shock absorbers, in particular in automobile construction but also in sports shoes and walking boots, or as cushioning in ski boots and also as filling in orthopedic cushions. In addition, the ionic polymer dispersions can be used as nonflammable hydraulic fluids, lubricants or cleaners.

The following nonlimiting examples illustrate the invention.

### EXAMPLES

### a) Production of an Aqueous Polymer Dispersion

In a polymer reactor having a capacity of 2 liters and provided with blade stirrer and heating/cooling facility, 300 g of deionized water were heated to 85° C. under a nitrogen atmosphere. While stirring, 102 g of feedstream 1 and 14.0 g of feedstream 2 were added at this temperature. After 15 minutes, the remaining amounts of feedstream 1 and feedstream 2 were fed continuously commencing at the same time as constant flow rates into the polymerization mixture via separate inlets over a period of two hours.

Feedstream 1 was an aqueous emulsion produced from 96.3 g of deionized water, 5.6 g of sodium alkylsulfonate (Emulgator K30® from Bayer AG), 37.5 g of ethoxylated isooctylphenol (having an average of 25 ethylene oxide units; Emulgator 825® from BASF SE), 150 g of methacrylamide, 15.0 g of maleic acid, 488 g of styrene and 225 g of tert-butyl acrylate.

Feedstream 2 was a solution of 135 g of deionized water and 5.3 g of a 7.5% strength by weight aqueous solution of potassium peroxydisulfate.

After the introduction of feedstreams 1 and 2 was complete, the reaction mixture was stirred at 85° C. for a further 60 minutes and was subsequently cooled to room temperature (20-25° C.). The aqueous polymer dispersion obtained had a solids content of 55% by weight. The average particle diameter was found to be 210 nm.

The solids content was determined by drying a defined amount of the aqueous polymer dispersion (about 0.8 g) to constant weight at a temperature of 130° C. (about 2 hours) by means of the moisture determination apparatus HR73 from Mettler Toledo. Two measurements were carried out in each case. The value reported is the mean of these measurements.

The average particle diameter of the polymer particles was determined by dynamic light scattering on a 0.005-0.01 percent strength by weight aqueous dispersion at 23° C. by means of an Autosizer IIC from Malvern Instruments, GB. The value reported is the average diameter in the cumulative evaluation (cumulant z average) of the measured autocorrelation function (ISO standard 13321).

### b) Production of Ionic Polymer Dispersions

### Example 1

45 g of 1-ethyl-3-methylimidazolium thiocyanate were added at room temperature to 100 g of the aqueous polymer dispersion produced as described in section a) while stirring and the whole was homogeneously mixed. The water was subsequently removed under reduced pressure by means of a rotary evaporator (bath temperature: 80° C.). After a reduced pressure of 20 mbar (absolute) had been reached, the ionic polymer dispersion was left on the rotary evaporator for another 2 hours under these conditions.

### Example 2

The production of example 2 was carried out in a manner analogous to example 1 with the difference that 1-ethyl-3-methylimidazolium methanesulfonate was used instead of 1-ethyl-3-methylimidazolium thiocyanate.

### Example 3

The production of example 3 was carried out in a manner analogous to example 1 with the difference that 1-ethyl-3-methylimidazolium chloride was used instead of 1-ethyl-3-methylimidazolium thiocyanate.

### Example 4

The production of example 4 was carried out in a manner analogous to example 1 with the difference that 1-ethyl-3-methylimidazolium methanesulfate was used instead of 1-ethyl-3-methylimidazolium thiocyanate.

### c) Measurement of the Shear Stress

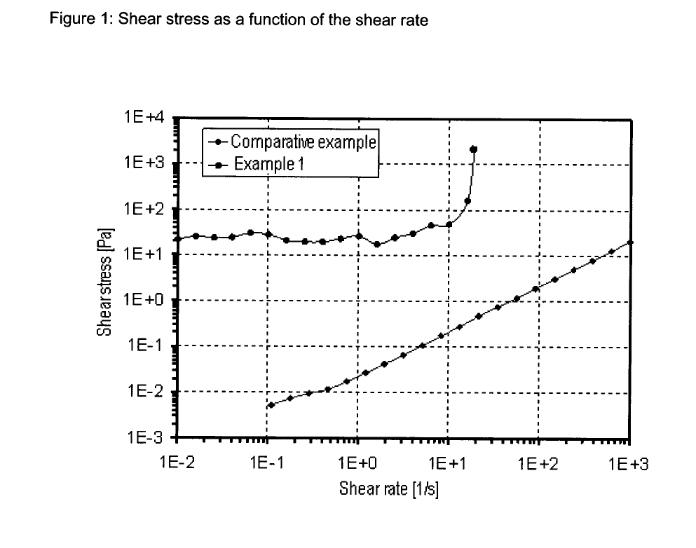

The measurement of the shear stress of the ionic polymer dispersion obtained as described in example 1 was carried out as a function of the shear rate and was carried out in a shear stress-controlled rotational viscometer MCR301 from Physica Messtechnik GmbH (double gap geometry DG 26.7; measuring body, internal radius: 12.33 mm, external radius: 13.33 mm; measuring cup, internal radius: 11.913 mm, external radius: 13.796 mm) at 25° C. The measurement was commenced at a low shear rate and the shear rate was slowly increased to a maximum. It can clearly be seen from FIG. 1 that the shear stress is virtually constant over a large shear range and then increases suddenly at a shear rate of about 18 s⁻¹. In the subsequent lowering of the shear rate, the shear stress similarly decreases suddenly and on lowering the shear stress further oscillates toward the low constant level. This behavior of the shear stress is typical of dilatant behavior. In a comparative experiment, the analogous measurement was carried out using 1-ethyl-3-methylimidazolium thiocyanate alone (i.e. without polymer particles). Here, it was found that the shear stress increases linearly with increasing shear rate and subsequently decreases linearly with decreasing shear rate, which corresponds to the behavior of a Newtonian liquid. The corresponding values of the shear stress as a function of the increasing shear rate are likewise shown in FIG. 1.

1. A process for producing a dispersion of polymer particles in an ionic liquid (ionic polymer dispersion), wherein an aqueous dispersion of polymer particles (aqueous polymer dispersion) is admixed with an ionic liquid and water is separated off from the mixture obtained.

2. The process according to claim 1, wherein the aqueous polymer dispersion comprises ≧30 and ≦90% by weight of water.

3. The process according to either claim 1 or 2, wherein ≧40 and ≦9900 parts by weight of ionic liquid are used per 100 parts by weight of polymer particles.

4. The process according to any of claims 1 to 3, wherein ≧90% by weight of the total amount of water comprised in the mixture is separated off.

5. The process according to any of claims 1 to 4, wherein the water removal is carried out at a pressure of <1 atm (absolute).

6. The process according to any of claims 1 to 5, wherein the ionic liquid has a melting point ≧−45 and ≦60° C.

7. The process according to any of claims 1 to 6, wherein 1-ethyl-3-methylimidazolium chloride, 1-ethyl-3-methylimidazolium methanesulfonate, 1-ethyl-3-methylimidazolium thiocyanate, 1-ethyl-3-methylimidazolium ethylsulfate, 1-butyl-3-methylimidazolium methanesulfonate, 1-butyl-3-methylimidazolium chloride and/or 1-ethyl-3-methylimidazolium acetate is used as ionic liquid.

8. The process according to any of claims 1 to 7, wherein an aqueous polymer dispersion having dilatant properties is used.

9. An ionic polymer dispersion which can be obtained according to any of claims 1 to 7.

10. The use of an ionic polymer dispersion according to claim 9 for producing adhesives, sealants, polymer renders, paper coatings, fiber nonwovens, coating compositions and impact modifiers and also for consolidating sand, textile finishing, leather finishing or for modifying mineral binders and plastics.

11. An ionic polymer dispersion which can be obtained according to claim 8.

12. The use of an ionic polymer dispersion according to claim 11 as medium for transmitting torque in vibration dampers, revolution limiters or hydraulic clutches and as filling in shock absorbers.
